(19) United States
(12) Patent Application Publication
(10) Pub. No.: US 2006/0285460 A1
(43) Pub. Date: Dec. 21, 2006

(54) Method of managing optimum power control data in lead-in zone of high-density optical disc

(75) Inventors: Jin Woo Yu, Suwon-si (KR); Otsuka Tatsuhiro, Suwon-si (KR); Jong Jin Ko, Seoul (KR); Ji Seon Baek, Suwon-si (KR)

Correspondence Address: STEIN, MCEWEN & BUI, LLP, 1400 EYE STREET, NW, SUITE 300, WASHINGTON, DC, 20005, US

(73) Assignee: SAMSUNG ELECTRONICS CO., LTD., Suwon-si (KR)

(21) Appl. No.: 11/370,881

(22) Filed: Mar. 9, 2006

(30) Foreign Application Priority Data
Jun. 16, 2005 (KR) 2005-51948

(51) Int. Cl. G11B 20/10; G11B 7/12

(52) U.S. Cl. 369/47.53

(57) ABSTRACT

A method of managing optimum power control (OPC) data in a lead-in zone of a rewritable high-density optical disc, wherein an OPC back data zone is allocated in the lead-in zone of the rewritable high-density optical disc and OPC data is written in the OPC back data zone so that a subsequent OPC process can be immediately performed based on the written OPC data. The method includes allocating a specified zone used in performing an OPC process within the lead-in zone of the rewritable high-density optical disc, writing OPC data for the OPC process in the specified zone, reading the OPC data written in the specified zone, and performing the OPC process based on the read OPC data.

### CROSS-REFERENCE TO RELATED APPLICATIONS

This application claims the benefit of Korean Patent Application No. 2005-51948 filed on Jun. 16, 2005, in the Korean Intellectual Property Office, the disclosure of which is incorporated herein by reference.

### BACKGROUND OF THE INVENTION

1. Field of the Invention

An aspect of the present invention relates to a method of managing optimum power control (OPC) data in a lead-in zone of a rewritable high-density optical disc, wherein an OPC back data zone is allocated in the lead-in zone of the rewritable high-density optical disc and OPC data obtained in performing an OPC process is written in the OPC back data zone so that a subsequent OPC process can be immediately performed based on the OPC data written in the OPC data back zone.

2. Description of the Related Art

With advances in video and audio media technologies, a recording medium in which high-quality video and audio data can be recorded and stored for a lengthy period of time has been developed and made commercially available. An example of such a recording medium is an optical disc, such as a digital versatile disc (DVD). As the need for storage capacity approaches the limits of the capacity of the DVD, a new high-density optical disc is undergoing rapid standardization and advances. An example of such a new high-density optical disc is a rewritable Blu-ray disc (BD-RE).

As shown in FIG. 1, a BD-RE includes a clamping area, a transition area, a burst cutting area (BCA), and a lead-in zone allocated in sequence beginning at the inner periphery of the disc, a data zone allocated in the middle part of the disc, and a lead-out zone allocated at the outer periphery of the disc.

The lead-in zone is divided into a protection zone 1, a permanent information and control data (PIC) zone, a protection zone 2, an information area 2, an optimum power control (OPC) zone, a reserved zone, and an information area 1. The protection zone 1 and the PIC zone are pre-recorded areas where data is pre-recorded, but the remaining parts of the lead-in zone, the entire data zone, and the entire lead-out zone are rewritable areas where new data may be written and rewritten.

The BCA near the inner periphery of the disc is the first area which is accessed when a BD-RE disc is loaded into an optical disc apparatus. The BCA includes various important information regarding the particular disc on which it appears, such as a disc serial number and encryption information for disc copy protection, i.e., copy protection information (CPI).

The PIC zone is a zone in which a high-frequency modulated (HFM) groove is formed to record and store main information regarding the disc which is to be permanently preserved.

The general layout of the BD-RE is shown in FIG. 2.

When data is about to be recorded on a rewritable high-density optical disc having the layout of FIG. 2, an OPC process is performed to determine a recording power suitable for the particular disc on which the data is to be recorded. To this end, the OPC zone is provided in the lead-in area, and is used in performing the OPC process to determine the recording power suitable for recording the data on the rewritable high-density optical disc.

The OPC process is performed in a blank area of the OPC zone. However, the OPC zone ranges from a physical address of 0x1bc00 to a physical address of 0x1dc00 in a pre-groove formed on the disc. This pre-groove is formed when the disc is manufactured, and has a fixed frequency wobble which contains location information, i.e., physical address information, called Address in Pre-groove (ADIP) that identifies a particular location in the pre-groove. This OPC zone is such a large area that it takes about 30 seconds to erase the entire OPC zone. Therefore, it is not practical to erase the entire OPC zone each time the OPC process is performed. Instead, when a recording start command is inputted to the optical disc apparatus, a seek algorithm is used to locate a blank area in the OPC zone before the OPC process is performed. However, it takes at least 5 seconds to locate a blank area in the OPC zone depending on the seek algorithm being used. This is a problem, because the seek time to locate the blank area is added to the lead-in time (loading time), degrading system performance and making the OPC process inapplicable to a product set employing a Blu-ray disc.

### SUMMARY OF THE INVENTION

Therefore, it is an aspect of the invention to provide a method of managing optimum power control (OPC) data in a lead-in zone of a rewritable high-density optical disc, wherein a specified zone for use in performing an OPC process is allocated within the lead-in zone of the rewritable high-density optical disc and OPC data is written in the specified zone so that a subsequent OPC process can be immediately performed based on the written OPC data.

It is another aspect of the invention to provide a method of managing optimum power control (OPC) data in a lead-in zone of a rewritable high-density optical disc, wherein it is possible to reduce a variation in an OPC recording power found between identical apparatuses or identical discs by identifying a previously determined OPC recording power.

In accordance with an aspect of the invention, a method of managing optimum power control (OPC) data in a lead-in zone of a high-density optical disc includes allocating a specified zone used in performing an OPC process in the lead-in zone of the rewritable high-density optical disc, and writing OPC data in the specified zone.

The specified zone may be a back data zone allocated within an OPC zone of the lead-in zone.

Alternatively, the specified zone may be a back data zone allocated within a power calibration area (PCA) of the lead-in zone.

The back data zone may have a size of about 100 blocks.

The OPC data may include an end address for the OPC process and an optimum recording power which are updated and rewritten in the specified zone each time the OPC process is performed.

The high-density optical disc may be a Blu-ray disc (BD) or a digital versatile disc (DVD).

In accordance with another aspect of the invention, a method of managing optimum power control (OPC) data in a lead-in zone of a high-density optical disc includes allocating a specified zone used in performing an OPC process in the lead-in zone of the rewritable high-density optical disc, reading OPC data written in the specified zone, and performing the OPC process based on the read OPC data.

The specified zone may be a back data zone allocated within an OPC zone of the lead-in zone.

Alternatively, the specified zone may be a back data zone allocated within a power calibration area (PCA) of the lead-in zone.

In accordance with another aspect of the invention, a method includes performing an optimum power control (OPC) process for a recording medium including a lead-in zone, and writing OPC data obtained during the OPC process in a specified zone in the lead-in zone of the recording medium.

In accordance with another aspect of the invention, a method includes determining optimum power control (OPC) data obtained during a previous OPC process performed for a recording medium, and performing another OPC process for the recording medium based on the determined OPC data.

In accordance with another aspect of the invention, a method includes performing an optimum power control (OPC) process for a recording medium using an OPC zone in a lead-in zone of the recording medium, and writing an end address in the OPC zone at which the OPC process was completed and an optimum OPC recording power determined in the OPC process in a back data zone (BDZ) in the OPC zone.

In accordance with another aspect of the invention, an apparatus includes an optical pickup that reads data from and writes data on a recording medium, and an optimum power control (OPC) process controller that controls the optical pickup to write date in and read data from an OPC zone in a lead-in zone of the recording medium to perform an OPC process for the recording medium, and controls the optical pickup to write an end address in the OPC zone at which the OPC process was completed and an optimum OPC recording power determined in the OPC process in a back data zone (BDZ) in the OPC zone.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic diagram illustrating the track structure of a rewritable high-density optical disc (BD-RE);

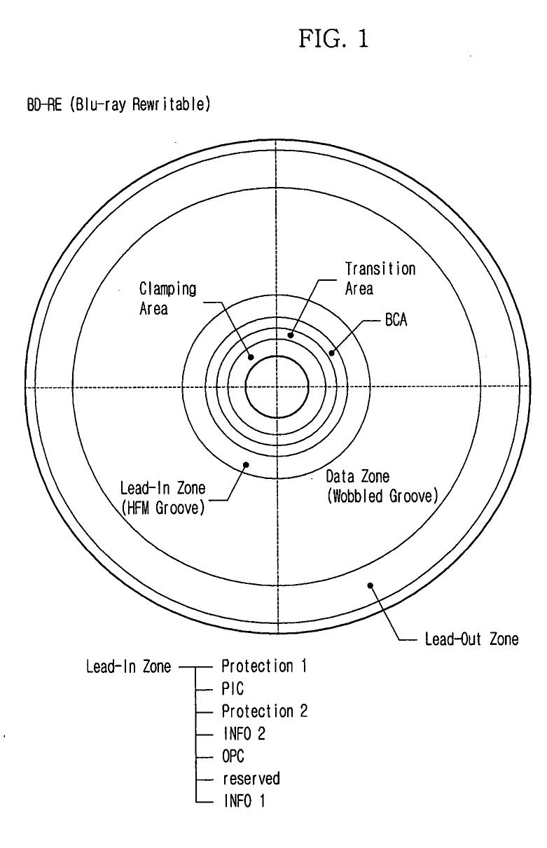

FIG. 2 is a tabular diagram showing the layout of the rewritable high-density optical disc (BD-RE);

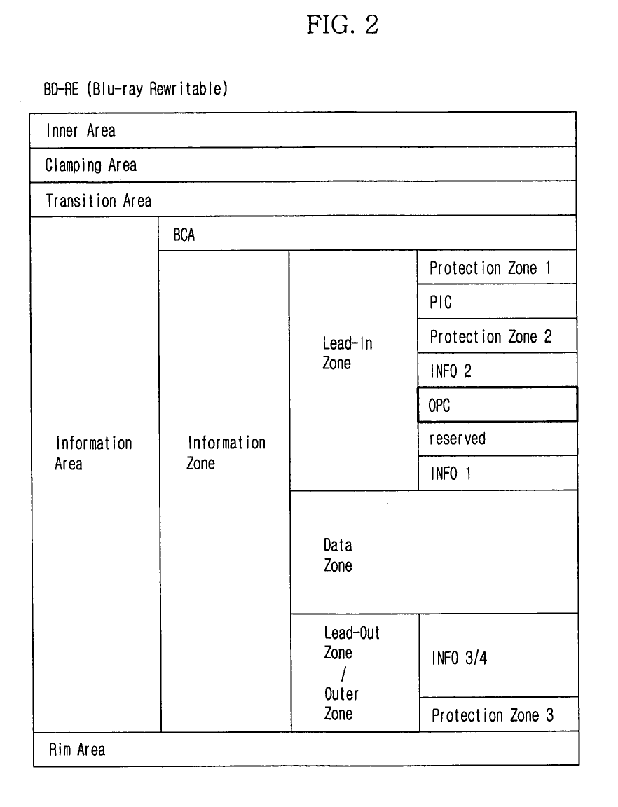

FIG. 3 is a diagram showing the layout of a rewritable high-density optical disc according to an embodiment of the present invention;

FIG. 4 is a block diagram illustrating the configuration of an optical disc apparatus for the rewritable high-density optical disc according to an embodiment of the present invention; and

FIG. 5 is a flow chart illustrating a method of managing optimum power control data in a lead-in zone of the rewritable high-density optical disc according to an aspect of the present invention.

### DETAILED DESCRIPTION OF THE EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

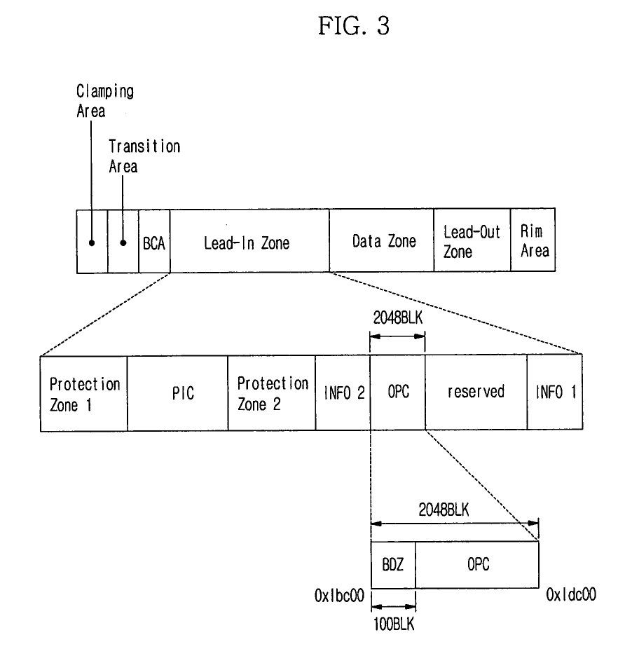

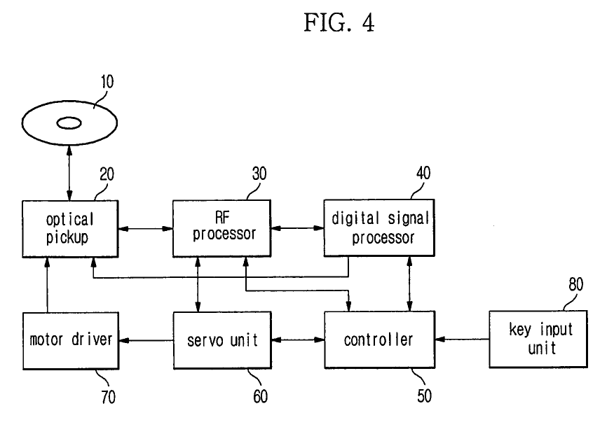

FIG. 3 is a diagram showing the layout of a rewritable high-density optical disc according to an embodiment of the present invention. As shown in FIG. 3, a rewritable high-density optical disc 10 shown in FIG. 4, for example, a rewritable Blu-ray disc (BD-RE), is divided into areas including a clamping area, a transition area, a burst cutting area (BCA), a lead-in zone, a data zone, a lead-out zone, and a rim area.

The lead-in zone is divided into a protection zone 1, a permanent information and control data (PIC) zone, a protection zone 2, an information area 2, an OPC zone, a reserved zone, and an information area 1.

When data is about to be recorded on the rewritable high-density optical disc such as a BD-RE, an OPC process is performed in the OPC zone in the lead-in area to determine a recording power suitable for the particular disc on which the data is to be recorded. The OPC zone for this OPC process ranges from a physical address of 0x1bc00 to a physical address of 0x1dc00 in the pre-groove on the disc (about 2048 blocks). An OPC back data zone (hereinafter, BDZ) having a specific size (about 100 blocks or some other predetermined size) is allocated in the OPC zone. Various OPC data which are obtained in performing the OPC process (for example, an end physical address in the pre-groove on the disc at which the OPC process was completed and an optimum OPC recording power that was determined in the OPC process) are stored in the BDZ. Afterwards, by reading the end physical address from the BDZ allocated in the OPC zone, a subsequent OPC process can be immediately performed beginning at a physical address following the end physical address read from the BDZ, thereby eliminating the seek time required to locate a blank area in the OPC zone using a conventional seek algorithm of the related art.

Although the preceding discussion has been directed to an OPC zone of a high-density optical disc such as a BD-RE, both the preceding discussion and the following discussion are equally applicable to a power calibration area (PCA) of a DVD which is similar to the OPC zone of the high-density optical disc.

The BDZ may be allocated in a specific size (about 100 blocks or some other predetermined size) at any part of the OPC zone, such as the beginning of the OPC zone (at a physical address of 0x1bc00), the middle of the OPC zone or the end of the OPC zone.

FIG. 4 is a block diagram illustrating the configuration of an optical disc apparatus for the rewritable high-density optical disc according to an embodiment of the present invention. The optical disc apparatus includes the high-density optical disc 10, an optical pickup 20, a radio-frequency (RF) processor 30, a digital signal processor 40, a controller 50, a servo unit 60, a motor driver 70, and a key input unit 80.

The optical pickup 20 performs an optical pickup operation on the high-density optical disc 10 to read data from the high-density optical disc 10 or to record data on the high-density optical disc 10.

The RF processor 30 modulates the data read by the optical pickup 20 into an RF signal. The RF processor 30 also performs an automatic laser power control operation to optimally control the output of a laser diode (LD) for reading from or recording on the high-density optical disc 10.

The digital signal processor 40 converts the RF signal modulated by the RF processor 30 into digital data and demodulates the converted data, and also modulates data to be recorded. The controller 50 controls the optical pickup 20, the RF processor 30, the digital signal processor 40, and the servo unit 60 in response to input commands of the user, and supplies focusing and tracking servo on/off commands to the servo unit 60.

The servo unit 60 generates focusing and tracking signals for controlling the optical pickup 20 and a drive signal for driving a spindle on which the high-density optical disc 10 is mounted using the RF signal modulated by the RF processor 30 under the control of the controller 20.

The motor driver 70 performs a servo control operation to change a rotation speed of the spindle on which the high-density optical disc 10 is mounted and to control a focusing state and a data read or write position of the optical pickup 20 under the control of the servo unit 60.

The key input unit 80 is used to input key signals to the controller 50 indicating opening or closing of a disc tray, a power on or off operation of the optical disc apparatus, and data recording, reproducing, or erasing of the high-density optical disc 10.

A description will now be given of the operations of a method of managing the OPC data in the lead-in zone of the rewritable high-density optical disc having the configuration described above.

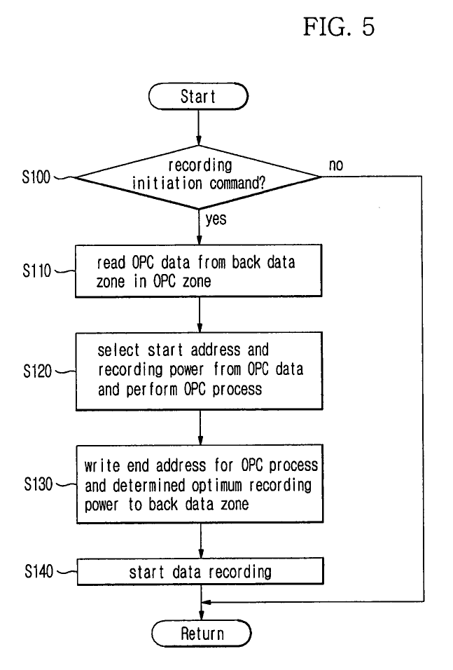

FIG. 5 is a flow chart illustrating the method of managing the OPC data in the lead-in zone of the rewritable high-density optical disc according to an aspect of the present invention.

When the user inputs a recording initiation command via the key input unit 80 to record data on the high-density optical disc 10 having the layout of FIG. 3, the controller 50 sends the recording initiation command to the optical pickup 20 via the digital signal processor 40 and the RF processor 30 (operation S100).

The optical pickup 20 reads the OPC data from the BDZ allocated within the OPC zone of the lead-in zone of the rewritable high-density optical disc 10 prior to performing the OPC process to determine a recording power suitable for the particular disc on which the data is to be recorded (operation S110). The BDZ is allocated in the OPC zone (ranging from a physical address of 0x1bc00 to a physical address of 0x1dc00 in the pre-groove on the disc) to store various OPC data obtained in performing the OPC process (for example, an end physical address in the pre-groove on the disc at which the OPC process was completed and an optimum OPC recording power that was determined in the OPC process).

It takes about 0.5 seconds to read the OPC data from the BDZ in the OPC zone.

Afterwards, a start physical address in the pre-groove on the disc and a recording power for performing the OPC process are selected based on the end physical address and the optimum OPC recording power in the OPC data read from the BDZ, and the OPC process is performed (operation S120). For example, the start physical address may be set to a physical address immediately following the end physical address, and the recording power may be set to the optimum OPC recording power. During the OPC process, recording and measurement are performed through a power swing based on data written in the OPC and read from the OPC zone by the optical pickup 20 under control of the controller 50, and an optimum OPC recording power is determined through modulation and a Kappa curve under control of the controller 50. The OPC process is well known in the art, and thus will not be described in detail here.

Then, an end physical address in the pre-groove on the disc at which the OPC process was completed and the optimum OPC recording power that was determined in the OPC process are stored in the BDZ within the OPC zone (operation S130). Finally, the optical pickup 20 starts to record data by irradiating the high-density optical disc 10 with laser light of the optimum recording power stored in the BDZ (operation S140).

It takes about 0.5 seconds to store the end address at which the OPC process was completed and the optimum OPC recording power that was determined in the OPC process in the BDZ within the OPC zone.

Consequently, a subsequent OPC process can be immediately performed by selecting a start physical address based on the end physical address in the OPC data stored in the BDZ within the OPC zone, thereby eliminating the seek time required to locate a blank area of the OPC zone using a conventional seek algorithm of the related art and reducing the lead-in time (loading time) of the high-density optical disc 10.

An aspect of the present invention is to provide an algorithm which significantly reduces the seek time required to locate a blank area in the OPC zone for use in performing the OPC process to determine a suitable recording power. Physical operations of the algorithm according to an aspect of the present invention described above can be observed with an oscilloscope. While the seek time to locate a blank area in the OPC zone for use in performing the OPC process is at least 5 seconds using a conventional seek algorithm of the related art, the time needed to read the end physical address at which the previous OPC process was completed from the BDZ within the OPC zone is less than about 0.5 seconds using the algorithm according to an aspect of the present invention described above. Overall, the algorithm according to an aspect of the present invention described above contributes to a reduction of the lead-in time (loading time) by about 4.0 seconds compared to the lead-in time (loading time) achieved by using a conventional seek algorithm of the related art.

In addition, by reading the optimum OPC recording power that was determined in the previous OPC process from the BDZ within the OPC zone, it is possible to reduce a variation in an OPC recording power found between identical apparatuses or identical discs.

The above description of one embodiment of the present invention has centered on the rewritable Blu-ray disc (BD-RE) as the high-density optical disc 10. However, the present invention is not limited to the rewritable Blu-ray disc, but is also applicable to a rewritable DVD and provides the same results when applied to the rewritable DVD as it does when applied to the rewritable Blu-ray disc. As indicated above, the rewritable DVD has a power calibration area (PCA) which is similar to the OPC zone of a high-density optical disc such as the rewritable Blu-ray disc (BD-RE).

As is apparent from the above description, an aspect of the present invention provides a method of managing OPC data in a lead-in zone of a rewritable high-density optical disc, wherein a specified zone for an OPC process is allocated within the lead-in zone of the rewritable high-density optical disc and OPC data is written in the specified zone so that a subsequent OPC process can be immediately performed based on the written OPC data. Consequently, the method reduces the lead-in time (loading time) by shortening the time needed to locate a blank area in the OPC zone for use in performing the OPC process, thereby enhancing overall system performance.

In addition, by reading the optimum OPC recording power that was determined in the previous OPC process from the BDZ in the OPC zone, it is possible to reduce a variation in an OPC recording power found between identical apparatuses or identical discs.

Although the invention has been described above as being applicable to a high-density optical disc such as a rewritable Blu-ray disc (BD-RE) and to a DVD, the invention is equally applicable to any recording medium for which an OPC process is performed.

Also, although the invention has been described above in terms of storing OPC data obtained in performing an OPC process in a back data zone (BDZ) allocated within an OPC zone in a lead-in zone of a recording medium, the invention is not limited to this example, but the OPC data may be stored in any suitable place in the lead-in zone or elsewhere on the recording medium.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of managing optimum power control (OPC) data in a lead-in zone of a high-density optical disc, comprising:
allocating a specified zone used in performing an OPC process in the lead-in zone of the rewritable high-density optical disc; and
writing OPC data for the OPC process to the specified zone.

2. The method of claim 1, wherein the specified zone is a back data zone allocated within an OPC zone of the lead-in zone.

3. The method of claim 1, wherein the specified zone is a back data zone allocated within a power calibration area (PCA) of the lead-in zone.

4. The method of claim 3, wherein the back data zone has a size of about 100 blocks.

5. The method of claim 1, wherein the OPC data includes an end address for the OPC process and an optimum OPC recording power which are updated and rewritten in the specified zone each time the OPC process is performed.

6. The method of claim 1, wherein the high-density optical disc is a Blu-ray disc (BD).

7. The method of claim 1, wherein the high-density optical disc is a digital versatile disc (DVD).

8. A method of managing optimum power control (OPC) data in a lead-in zone of a high-density optical disc, comprising:
allocating a specified zone used in performing an OPC process in the lead-in zone of the rewritable high-density optical disc; and
reading OPC data written in the specified zone; and
performing the OPC process based on the read OPC data.

9. The method of claim 8, wherein the specified zone is a back data zone allocated within an OPC zone of the lead-in zone.

10. The method of claim 8, wherein the specified zone is a back data zone allocated within a power calibration area (PCA) of the lead-in zone.

11. A method comprising:
performing an optimum power control (OPC) process for a recording medium comprising a lead-in zone; and
writing OPC data obtained during the OPC process in a specified zone in the lead-in zone of the recording medium.

12. The method of claim 11, further comprising:
reading the written OPC data from the specified zone; and
performing another OPC process based on the read OPC data.

13. The method of claim 11, wherein the lead-in zone comprises a zone used in performing the OPC process; and
wherein the OPC data comprises an end address in the zone used in performing the OPC process at which the OPC process was completed.

14. The method of claim 13, further comprising:
reading the written OPC data from the specified zone;
selecting a start address in the OPC zone based on the end address in the read OPC data; and
performing another OPC process starting at the start address in the OPC zone.

15. The method of claim 14, wherein the start address follows the end address.

16. The method of claim 11, wherein the OPC data comprises an optimum OPC recording power determined in the OPC process.

17. The method of claim 16, further comprising:
reading the written OPC data from the specified zone;
selecting a recording power based on the optimum OPC recording power in the read OPC data; and
performing another OPC process using the selected recording power.

18. The method of claim 17, wherein the selected recording power is equal to the optimum OPC recording power.

19. The method of claim 11, wherein the recording medium is a high-density optical disc having a substantially greater recording capacity than a digital versatile disc (DVD);
wherein the lead-in zone comprises an OPC zone used in performing the OPC process; and
wherein the specified zone is a back data zone (BDZ) in the OPC zone.

20. The method of claim 19, wherein the BDZ has a size of about 100 blocks.

21. The method of claim 20, wherein the high-density optical disc is a rewritable Blu-ray disc (BD-RE).

22. The method of claim 11, wherein the recording medium is a digital versatile disc (DVD);
wherein the lead-in zone comprises a power calibration area (PCA) used in performing the OPC process; and
wherein the specified zone is a back data zone (BDZ) in the PCA.

23. The method of claim 22, wherein the BDZ has a size of about 100 blocks.

24. A method comprising:
determining optimum power control (OPC) data obtained during a previous OPC process performed for a recording medium; and
performing another OPC process for the recording medium based on the determined OPC data.

25. The method of claim 24, wherein the recording medium comprises a lead-in zone;
wherein the OPC data was written in a specified zone in the lead-in zone after the previous OPC process was completed; and
wherein the determining of the OPC data comprises reading the written OPC data from the specified zone.

26. A method comprising:
performing an optimum power control (OPC) process for a recording medium using an OPC zone in a lead-in zone of the recording medium; and
writing an end address in the OPC zone at which the OPC process was completed and an optimum OPC recording power determined in the OPC process in a back data zone (BDZ) in the OPC zone.

27. The method of claim 26, further comprising:
reading the end address and the optimum OPC recording power from the BDZ;
setting a start address in the OPC zone to be used in performing a subsequent OPC process to an address in the OPC zone following the end address read from the BDZ;
setting a recording power to be used in performing the subsequent OPC process to the optimum OPC recording power read from the BDZ;
performing the subsequent OPC process starting at the start address in the OPC zone with the recording power set to the optimum OPC recording power read from the BDZ; and
writing an end address in the OPC zone at which the subsequent OPC process was completed and an optimum OPC power determined in the subsequent OPC process in the BDZ.

28. An apparatus comprising:
an optical pickup that reads data from and writes data on a recording medium; and
an optimum power control (OPC) process controller that
controls the optical pickup to write date in and read data from an OPC zone in a lead-in zone of the recording medium to perform an OPC process for the recording medium, and
controls the optical pickup to write an end address in the OPC zone at which the OPC process was completed and an optimum OPC recording power determined in the OPC process in a back data zone (BDZ) in the OPC zone.

29. The apparatus of claim 28, wherein the OPC process controller further
controls the optical pickup to read the end address and the optimum OPC recording power from the BDZ,
sets a start address in the OPC zone to be used in performing a subsequent OPC process to an address in the OPC zone following the end address read from the BDZ,
sets a recording power to be used in performing the subsequent OPC process to the optimum OPC recording power read from the BDZ,
controls the optical pickup to write data in and read data from the OPC zone starting at the start address in the OPC zone with the recording power set to the optimum OPC recording power read from the BDZ to perform the subsequent OPC process, and
controls the optical pickup to write an end address in the OPC zone at which the subsequent OPC process was completed and an optimum OPC power determined in the subsequent OPC process in the BDZ.
